(19) United States
(12) Patent Application Publication
(10) Pub. No.: US 2008/0210769 A1
(43) Pub. Date: Sep. 4, 2008

(54) HEATING SYSTEM, DRYING MACHINE HAVING THE HEATING SYSTEM, AND METHOD OF CONTROLLING THE HEATING SYSTEM

(75) Inventors: Hea Kyung Yoo, Seoul (KR); Seog Ho Go, Gimhae-Si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/869,405

(22) Filed: Oct. 9, 2007

(30) Foreign Application Priority Data
Oct. 9, 2006 (KR) 10-2006-0098066

(51) Int. Cl. F26B 21/00; F26B 19/00

(52) U.S. Cl. 237/2 R; 34/68

(57) ABSTRACT

A heating system and a method of controlling the heating system are provided. When a heating unit and a switch are turned on and off repeatedly by the predetermined number of times or more, only some of heaters of the heating unit are turned on, thereby increasing service life of the heating unit and the switch.

### CROSS-REFERENCE TO RELATED APPLICATIONS

The present application claims priority under 35 U.S.C. 119 and 35 U.S.C. 365 to Korean Patent Application No. 10-2006-098066, filed on Oct. 9, 2006, which is hereby incorporated by reference in its entirety.

### BACKGROUND

The present disclosure relates to a heating system, a drying machine having the heating system, and a method of controlling the heating system.

Generally, a drying machine is an appliance that dries laundry. Heated air is supplied into the drying machine by a heating system. A heater may be applied as the heating system. The heater is turned on and off by a switch to maintain an internal space of a drum of the drying machine within a predetermined temperature range. That is, the heater is frequently turned on and off to dry the laundry at a proper temperature, thereby preventing the laundry from being damaged.

However, since the heater of the drying machine is frequently turned on and off by the switch, service life of the switch and the heater may be shortened. For example, when a filter of the drying machine is clogged by foreign objects such as nap, the internal space of the drum is overheated and thus the number of on/off times of the switch and heater increases steeply. This results in reducing the service life of the switch and heater.

### SUMMARY

Embodiments provide a heating system and a method of controlling the heating system that can increase service life of a switch and a heater by reducing the number of on/off times of the heater and switch.

In one embodiment, a heating system includes a heating unit having a plurality of heaters for heating air flowing into a drum; switching units for turning on and off the respective heaters; and a control unit for turning on only some of the heaters when it is determined that the heating unit is turned on and off repeatedly by the predetermined number of times or more.

In another embodiment, a heating system includes a heating unit having high and low temperature heaters for heating air flowing into a drum; switching units for turning on and off the respective high and low temperature heaters; and a control unit for turning on only one of the high and low temperature heaters when it is determined that the heating unit is turned on and off repeatedly by the predetermined number of times or more.

In still another embodiment, a drying machine includes a drum in which laundry is loaded; an input unit for selecting an amount of the laundry and/or a kind of the laundry; a heating unit having a plurality of heaters for heating air flowing into a drum; switching units for turning on and off the respective heaters; and a control unit for turning on only some of the heaters when it is determined that the heating unit is turned on and off repeatedly by the predetermined number of times or more.

In still yet another embodiment, a method of controlling a heating system includes drying laundry as a heating unit having a plurality of heaters is turned on and off; determining the number of on/off times of the heating unit; and maintaining an on-state of only some of the heaters of the heating unit when it is determined that the heating unit is turned on and off repeatedly by the predetermined number of times or more.

In still yet another embodiment, a method of controlling a heating system includes drying laundry as a heating unit having high and low temperature heaters is turned on and off; determining the number of on/off times of the heating unit; and maintaining an on-state of only one of the heaters of the heating unit when it is determined that the heating unit is turned on and off repeatedly by the predetermined number of times or more.

In still yet further another embodiment, a method of controlling a heating system includes drying laundry as a heating unit having a plurality of heaters is turned on and off; determining the number of on/off times of the heating unit; and maintaining an on-state of only some of the heaters of the heating unit in accordance with an amount of the laundry and a kind of the laundry when it is determined that the heating unit is turned on and off repeatedly by the predetermined number of times or more.

The details of one or more embodiments are set forth in the accompanying drawings and the description below. Other features will be apparent from the description and drawings, and from the claims.

### BRIEF DESCRIPTION OF THE DRAWINGS

FIG. 1 is a sectional view of a drying machine having a heating system according to an embodiment.

FIG. 2 is a block diagram of a heating system depicted in FIG. 1.

FIG. 3 is a flowchart illustrating a method of controlling a heating system according to an embodiment.

### DETAILED DESCRIPTION OF THE EMBODIMENTS

Reference will now be made in detail to the embodiments of the present disclosure, examples of which are illustrated in the accompanying drawings.

A heating system of an embodiment may be applied to a drying machine and a washing machine having a drying function. The drying machines (including the washing machine having the drying function) may be classified in a condensing type drying machine and an exhaust type drying machine. The condensing type drying machine dries laundry by close-circulating heated air. Therefore, the condensing type drying machine further includes a condensing unit for removing moisture by condensing humidity air. The exhaust type drying machine does not require the condensing unit as it is designed to exhaust humidity heated air to an external side. The following will describe a drying machine having a heating system of an embodiment.

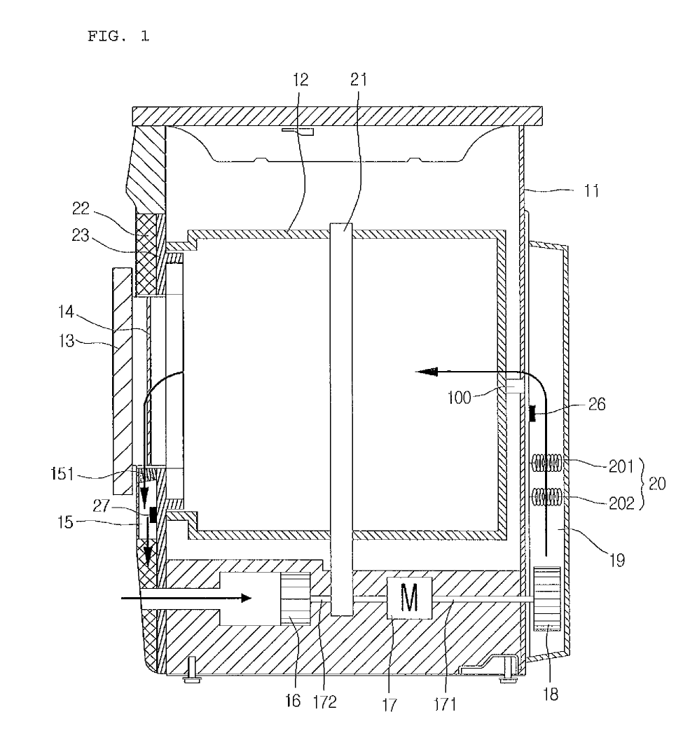

FIG. 1 is a sectional view of a drying machine having a heating system according to an embodiment.

Referring to FIG. 1, the drying machine includes a cabinet 11 defining an outer appearance thereof. A front cover 23 is coupled to a front portion of the cabinet 11. A front frame is coupled to the front cover 23. A laundry loading inlet (not shown) is formed on the front cover 23 and front frame 22. A door 13 is pivotally installed on the laundry loading inlet.

A drum 12 is disposed in the cabinet 11 to be capable of rotating. A front portion of the drum 12 is supported by the front cover 23. A rear portion of the drum 12 is supported on the cabinet 11 by a rotational shaft 100. At least one bar-shaped lift may be disposed on an inner surface of the drum 12 to lift the laundry when the drum 12 rotates. The drum 12 rotates by a driving unit. The driving unit includes a belt 21 installed around an outer circumference of the drum 12 and a motor 17 rotating the belt 21. Alternatively, the driving unit may include only a motor that is directly connected to the rotational shaft of the drum 12.

The motor 17 has a first rotational shaft 172 to which a cooling fan 16 and the belt 21 are coupled and a second rotational shaft 171 to which a drying fan 18 is coupled. At this point, the belt 21 may be coupled to the first rotational shaft 172 by a pulley (not shown). The cooling fan 16 circulates internal air of the drum 12 and the drying fan 171 sucks air and directs the sucked air into the drum 12.

A drying duct 19 is connected to the rear portion of the drum 12. At this point, an air inlet (not shown) is formed in the rear portion of the drum 1. The drying duct 19 communicates with the internal space of the drum 12 through the air inlet (not shown). The drying fan 18 and a heating unit 20 may be disposed in the drying duct 19. The heating unit 20 may include at least two heaters 201 and 202. A temperature sensor 26 may be disposed in the drying duct 19 to measure a temperature of the air heated by the heating unit 20.

A circulation duct 15 connected to the laundry loading inlet (not shown) may be disposed on the front portion of the drum 12. A temperature sensor 27 for measuring a temperature of air discharged from the drum 12 may be disposed in the circulation duct 15.

A lint filter 151 for filtering off foreign objects such as nap contained in the air may be further disposed in the circulation duct 15. In addition, a lint filter 14 is further disposed on the door 13 to filter off the foreign objects such as nap contained in the humidity air discharged from the drum 12.

A condenser (not shown) may be disposed under the drum 12 to condense humidity air discharged from the circulation duct 15 through the heat exchange between the humidity air and room air that is separately introduced. Therefore, the air discharged from the drum 12 close-circulates along the circulation duct 15, the condenser (not shown), and the drying duct 19. In addition, the introduced room air is exhausted through the condenser to an external side. As described above, the moisture contained in the heated, humidity air is removed by the heat exchange between the heated, humidity air and the cool room air.

The following will describe operation of the above-described drying machine.

Referring again to FIG. 1, when electric power is applied to the drying machine, the motor 17 is driven, by which the belt 21 connected to the first rotational shaft 172 of the motor 17 rotates to rotate the drum 12. At this point, the laundry loaded in the drum 12 is lifted and falls.

In addition, the heating unit 20 disposed in the drying duct 19 operates. At this point, electric power is applied to all of the heaters 201 and 202 of the heating unit 20 so that all of the heaters 201 and 202 generate heat to heat the air circulating along the drying duct 19.

In addition, the drying fan 18 and the cooling fan 16 that are respectively connected to the second and first rotational shafts 171 and 172 of the motor 17 rotate, by which the air in the drying duct 19 is directed into the drum 12 after being heated by the heating unit 20. The laundry loaded in the drum 12 is heated by the heated air directed from the drying duct 19, by which the moisture contained in the laundry is vaporized and thus contained in the heated air.

The heated air containing the moisture is directed to the circulation duct 15. At this point, the foreign objects contained in the humidity air are filtered off by the lint filters 14 and 151. Subsequently, the humidity air flows along the circulation duct 15 and is recovered to the drying duct 19 via the condenser (not shown). At this point, the room air is directed to the condenser and subsequently discharged to the room. Therefore, the moisture contained in the humidity air is removed by the condenser.

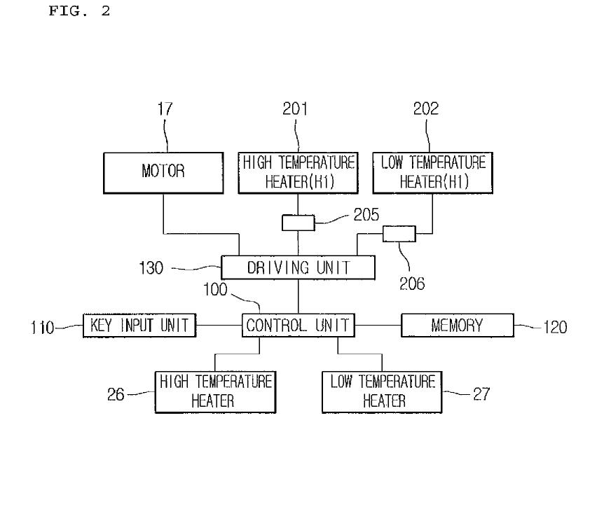

Meanwhile, the temperature sensor 26 disposed in the drying duct 19 and the temperature sensor 27 disposed in the circulation duct 15 transmit temperature information to a control unit 100 (see FIG. 2). The control unit 100 determines an internal temperature of the drum 12 in accordance with the temperature information from the temperature sensors 26 and 27. When it is determined that the internal temperature of the drum 12 reaches a predetermined upper limit value, the control unit 100 turns off all of the heaters 201 and 202 of the heating unit 20.

Even after the heaters 201 and 202 of the heating unit 20 are turned off, the temperature sensors 26 and 27 continues to detect the temperatures and transmits the temperature information to the control unit 100. When it is determined that the internal temperature of the drum 12 reaches a predetermined lower limit value, the control unit 100 turns on all of the heaters 201 and 202 of the heating unit 20 to increase the internal temperature of the drum 12.

As described above, as the heaters 201 and 202 of the heating unit 20 are turned on and off repeatedly, the internal temperature of the drum 12 is maintained within a predetermined temperature range, thereby reliably drying the laundry.

FIG. 2 is a block diagram of a heating system depicted in FIG. 1.

Referring to FIG. 2, a heating system includes the control unit 100. A key input unit 110 for inputting an operation command and/or drying condition of the drying machine is connected to the control unit 100. At this point, a user can input an amount of laundry to be dried and a kind of the laundry through the key input unit 110. Here, the amount of the laundry may be subdivided into a large volume mode, a medium volume mode, and a small volume mode. The kind of the laundry may be subdivided into a high temperature drying cloth mode, a medium temperature drying cloth mode, and a low temperature drying cloth mode.

The temperature sensors 26 and 27 for detecting temperatures of the air flowing along the drying duct 19 and the circulation duct 15 are connected to the control unit 100. A memory unit 120 for storing a variety of data and commands input from the key input unit 110 is connected to the control unit 100. A driving unit 130 for driving the drying machine in accordance with an input condition input through the key input unit 110 is electrically connected to the control unit 100. The motor 17 for rotating the drum 12 is electrically connected to the driving unit 130.

The heating unit 20 is electrically connected to the driving unit 120. The heating unit 20 includes the plurality of heaters 201 and 202 heating the air flowing into the drum 12. At this point, the heaters 201 and 202 may have different heat generation capacities or an identical heat generation capacity.

Switching units 205 and 206 for turning on and off the respective heaters may be disposed between the driving unit 120 and the heaters 201 and 202. Relays may be used as the switching units 205 and 206. Although only two heaters 201 and 202 are illustrated in FIG. 2, the present invention is not limited to this embodiment. That is, three or more heaters may be connected to the driving unit 120.

When it is determined that the heating unit 20 is turned on and off repeatedly by the predetermined number of times, the control unit 100 may turn on some of the heaters and turn off the rest.

At this point, the control unit 100 may turn on only the heater 202 having a relatively small heat generation capacity. For example, when the heating unit 20 has the heaters 201 and 202 having different heat generation capacities, the control unit 100 turns on the low temperature heater 202 having the relatively small heat generation capacity and turns off the high temperature heater 203 having the relatively large heat generation capacity.

Alternatively, the control unit 100 may turn on only the heater 203 having a relatively large heat generation capacity. For example, when the heating unit 20 has the heaters 201 and 202 having different heat generation capacities, the control unit 100 turns off the low temperature heater 202 having the relatively small heat generation capacity and turns on the high temperature heater 203 having the relatively large heat generation capacity.

Some of the heaters may be preset such that it is controlled to be turned on by the control unit 100 in accordance with the amount of the laundry or/and the kind of the laundry. For example, when it is determined that the heating unit 20 is turned on and off repeatedly by the predetermined number of times, the control unit 100 may turn on some of the heaters and turn off the rest. In addition, when the kind of the laundry is set as the low temperature drying cloth mode and it is determined that the heating unit 20 is turned on and off repeatedly by the predetermined number of times, the control unit 100 may turn on only the heater 202 having a relatively small heat generation capacity. In addition, even when the amount of the laundry is set as the large volume mode, the control unit 100 may turn on only the heater 202 having the relatively small heat generation capacity to prevent the damage of the laundry by the heat when the kind of the laundry is set as the lower temperature drying cloth mode.

The following will describe a method of controlling the heating system.

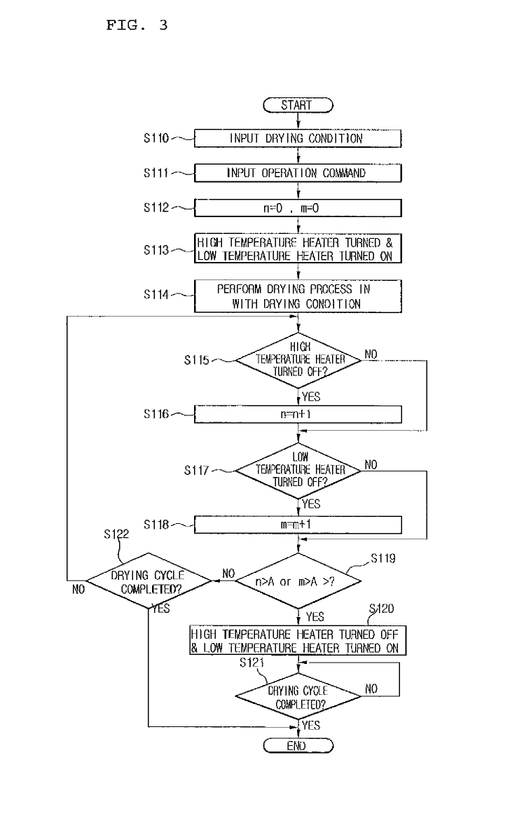

FIG. 3 is a flowchart illustrating a method of controlling a heating system according to an embodiment.

Referring to FIG. 3, the user inputs a drying condition through the key input unit 110 (S110). At this point, the user can selective a mode corresponding to the amount of the laundry and a mode corresponding to the kind of the laundry. Next, the user inputs an operation command using an operation button (S120).

When the operation command is input, the control unit 100 performs a reset operation to count the number of the on/off times of the heating unit 20. For example, when the heating unit 20 includes the two heaters 201 and 202 having different heat generation capacities, the control unit resets a count value n for counting the number of the on/off times of the high temperature heater 201 as 0 and resets a count value m for counting the number of the on/off times of the low temperature heater 202 as 0 (S112). Here, the numbers of the on/off times of the high and low temperature heaters 201 and 202 are identical to the numbers of the on/off times of the switching units 205,206.

In addition, all of the heaters 201 and 202 of the heating unit 20 are turned on in accordance with the drying condition input (S113) and the temperatures sensors 26 and 27 detect the internal temperature of the drum 12. The control unit 100 determines the internal temperature of the drum 12 in accordance with the temperature information from the temperature sensors 26 and 27 and turns on or off the heaters 201 and 202 of the heating unit 20. A drying process is performed while maintaining the internal temperature of the drum within a predetermined temperature range in accordance with the drying condition as described above (S114).

While the drying process is being performed, the control unit 100 counts the number of the on/off times of the heating unit 20. For example, the control unit 100 determines if there is a turning off of the high temperature heater 201 (S115). When it is determined that there is the turning off of the high temperature heater 201, the control unit 100 increases the count value n by 1 (S116). In addition, the control unit 100 determines if there is a turning off of the low temperature heater 202 (S117). When it is determined that there is the turning off of the low temperature heater 202, the control unit 100 increases the count value m by 1 (S118).

Further, when it is determined that the heating unit 20 is turned on and off repeatedly by the predetermined number or more, the control unit 100 turns on only the heater 202 of the heating unit 20. For example, the control unit 100 determines if at least one of the count values n and m reaches the predetermined number A (S119). When it is determined that at least one of the count values n and m reaches the predetermined number A, the high temperature heater 201 is controlled to be turned off and the low temperature heater 202 is controlled to be turned on.

Needless to say, it will be also possible that, When it is determined that at least one of the count values n and m reaches the predetermined number A, the high temperature heater 201 is controlled to be turned on and the low temperature heater 202 is controlled to be turned off.

It will be understood that the selection of the turning on of one of the high and low temperature heaters 201 and 202 of the heating unit 20 may be determined in accordance with the amount of the laundry and/or the kind of the laundry. When the amount of the laundry is set as the large capacity mode, the high temperature heater 201 is turned on while the low temperature heater 202 is turned off. When the amount of the laundry is set as the small capacity mode, the high temperature heater 201 is turned off while the low temperature heater 202 is turned on.

In this state, the drying process is continued. When the kind of the laundry is set as the high temperature drying cloth mode, the high temperature heater 201 is turned on while the low temperature heater 202 is turned off. When the kind of the laundry is set as the low temperature drying cloth mode, the high temperature heater 201 is turned off while the low temperature heater 202 is turned on.

Further, it is determined if the drying cycle is completed (S120). When it is determined that the drying cycle is being processed, the on-state of the low temperature heater 202 is maintained and the drying process is continued until the laundry is completely dried. When it is determined that the drying cycle is completed, the drying machine stops operating.

Meanwhile, when both of the counter values n and m do not reach the predetermined number A, it is determined if the drying cycle is completed (S122). At this point, when it is determined that the drying cycle is completed, the drying process is finished. On the contrary, when it is determined that the drying cycle is not completed, the drying process is continued in accordance with the input drying condition. That is, the processes following the process S114 are repeatedly performed. In this case, the on/off control of the high and low temperature heaters 201 and 202 is performed so that the internal temperature of the drum 12 is maintained within the predetermined temperature range in accordance with the input drying condition.

In addition, the predetermined number A may be 40 or more.

According to the above-described control method, the numbers of the on/off times of the heaters and switches can be reduced during a drying process. As a result, the service life of the switches increases, thereby reliably operating the drying machine.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A heating system comprising:
a heating unit having a plurality of heaters for heating air flowing into a drum;
switching units for turning on and off the respective heaters; and
a control unit for turning on only some of the heaters when it is determined that the heating unit is turned on and off repeatedly by the predetermined number of times or more.

2. The heating system according to claim 1, wherein the heaters of the heating unit have different heat generation capacities.

3. The heating system according to claim 1, wherein the control unit turns on only the heater having a relatively small heat generation capacity when it is determined that the heating unit is turned on and off repeatedly by the predetermined number of times or more.

4. The heating system according to claim 1, wherein, when it is determined that the heating unit is turned on and off repeatedly by less than the predetermined number of times, the control unit maintains a predetermined temperature range while turning on and off repeatedly all of the heaters.

5. The heating system according to claim 1, wherein the control unit turns on only some of the heaters when it is determined that at least one of the heaters of the heating unit is turned on and off repeatedly by the predetermined number of times or more.

6. A heating system comprising:
a heating unit having high and low temperature heaters for heating air flowing into a drum;
switching units for turning on and off the respective high and low temperature heaters; and
a control unit for turning on only one of the high and low temperature heaters when it is determined that the heating unit is turned on and off repeatedly by the predetermined number of times or more.

7. The heating system according to claim 6, wherein the control unit turns on only the low temperature heater when it is determined that the heating unit is turned on and off repeatedly by the predetermined number of times or more.

8. The heating system according to claim 6, wherein, when it is determined that the heating unit is turned on and off repeatedly by less than the predetermined number of times, the control unit maintains a predetermined temperature range while turning on and off repeatedly all of the heaters.

9. The heating system according to claim 6, wherein the control unit turns on only one of the high and low temperature heaters when it is determined that at least one of the heaters of the heating unit is turned on and off repeatedly by the predetermined number of times or more.

10. A drying machine comprising:
a drum in which laundry is loaded;
an input unit for selecting an amount of the laundry and/or a kind of the laundry;
a heating unit having a plurality of heaters for heating air flowing into a drum;
switching units for turning on and off the respective heaters; and
a control unit for turning on only some of the heaters when it is determined that the heating unit is turned on and off repeatedly by the predetermined number of times or more.

11. The drying machine according to claim 10, wherein some of the heaters are preset in the control unit to be turned on the heaters in accordance with the amount of the laundry and the kind of the laundry.

12. A method of controlling a heating system, comprising:
drying laundry as a heating unit having a plurality of heaters is turned on and off;
determining the number of on/off times of the heating unit; and
maintaining an on-state of only some of the heaters of the heating unit when it is determined that the heating unit is turned on and off repeatedly by the predetermined number of times or more.

13. The method according to claim 12, wherein the heaters that are maintained in the on-state have a relatively small heat generation capacity.

14. The method according to claim 12, wherein, when it is determined that the heating unit is turned on and off repeatedly by less than the predetermined number of times, a predetermined temperature range is maintained as all of the heaters are turned on and off repeatedly.

15. The method according to claim 12, wherein, when it is determined that at least one of the heaters of the heating unit is turned on and off repeatedly by the predetermined number of times or more, only some of the heaters are turned on.

16. A method of controlling a heating system, comprising:
drying laundry as a heating unit having high and low temperature heaters is turned on and off;
determining the number of on/off times of the heating unit; and
maintaining an on-state of only one of the heaters of the heating unit when it is determined that the heating unit is turned on and off repeatedly by the predetermined number of times or more.

17. The method according to claim 16, wherein the heater that is maintained in the on-state is the low temperature heater.

18. The method according to claim 16, wherein, when it is determined that the heating unit is turned on and off repeatedly by less than the predetermined number of times, a predetermined temperature range is maintained as all of the heaters are turned on and off repeatedly.

19. The method according to claim 16, wherein, when it is determined that at least one of the heaters of the heating unit is turned on and off repeatedly by the predetermined number of times or more, only one of the heaters is turned on.

20. A method of controlling a heating system, comprising:
drying laundry as a heating unit having a plurality of heaters is turned on and off;
determining the number of on/off times of the heating unit; and
maintaining an on-state of only some of the heaters of the heating unit in accordance with an amount of the laundry and a kind of the laundry when it is determined that the heating unit is turned on and off repeatedly by the predetermined number of times or more.

21. The method according to claim 20, wherein, as the amount of the laundry increases, some of the heaters, which have a relative large heat generation capacity, are turned on.
